(19) United States
(12) Patent Application Publication
(10) Pub. No.: US 2025/0052200 A1
(43) Pub. Date: Feb. 13, 2025

(54) INTEGRATING AN EXTINGUISHER INTO A "FIRE" ZONE OF A TURBOMACHINE

(71) Applicant: Safran Nacelles, GONFREVILLE-L'ORCHER (FR)

(72) Inventors: Patrick GONIDEC, Moissy-Cramayel (FR); Patrick André BOILEAU, Moissy-Cramayel (FR)

(73) Assignee: Safran Nacelles, GONFREVILLE-L'ORCHER (FR)

(21) Appl. No.: 18/722,944

(22) PCT Filed: Dec. 21, 2022
(86) PCT No.: PCT/FR2022/052459

§ 371 Date: Jun. 21, 2024

(30) Foreign Application Priority Data
Dec. 22, 2021 (FR) FR2114218

(51) Int. Cl. F02C 7/25; A62C 3/08; B64D 29/00

(52) U.S. Cl. CPC F02C 7/25; A62C 3/08; B64D 29/00

(57) ABSTRACT

An assembly for an aircraft gas turbine engine includes a nacelle extending substantially around a longitudinal axis and including a fixed structure disposed around the aircraft gas turbine engine, the fixed structure including an internal surface suitable for delimiting with an external surface of the gas turbine engine a fire zone of the nacelle, a thermal protection covering the internal surface of the fixed structure of the nacelle at the level of the fire zone of the nacelle, and an extinguisher designed to extinguish a fire in the fire zone of the nacelle, the extinguisher including a tank suitable for containing an extinguishing agent. The tank is located between the thermal protection and the internal surface of the fixed structure of the nacelle.

### FIELD OF THE INVENTION

This invention relates to an assembly for an aircraft turbojet engine, comprising a nacelle and a fire extinguishing device comprising at least one tank mounted on the nacelle.

### PRIOR ART

An aircraft conventionally comprises at least one propulsion system to ensure its propulsion. The propulsion system comprises a turbomachine, for example a turbojet engine or a turboprop engine.

The turbomachine comprises a fan, at least one compressor, a combustion chamber, at least one turbine, and a gas exhaust nozzle. For example, the turbomachine may comprise a low-pressure compressor and a high-pressure compressor, and a high-pressure turbine and a low-pressure turbine.

A turbojet engine may be a bypass turbojet engine, in which the mass of air taken in by the fan is divided into a primary flow, which traverses the at least one compressor, the combustion chamber and the at least one turbine, and a secondary flow, which is concentric with the primary flow.

The turbomachine is housed in a nacelle. The nacelle is attached to a pylon, or mast, which supports the turbomachine, the pylon being itself attached under a wing of the aircraft.

As illustrated in FIG. 1, a nacelle 1 may comprise an air intake upstream of the turbomachine 2, the upstream and the downstream being defined with respect to the direction of flow of the gas in the turbomachine 2 in operation, a fan casing 15 surrounding the fan of the turbomachine 2, an intermediate casing at least partially surrounding a compressor of the turbomachine 2, and an Internal Fixed Structure (IFS) 11. The internal fixed structure 11 surrounds at least the combustion chamber of the turbomachine 2. The expulsion nozzle 23 of the turbomachine is located downstream of the internal fixed structure 11.

A “fire” zone of the turbomachine is a zone in which it is necessary to be able to extinguish any fire that might break out there. A “fire” zone is thus defined by the possible presence of a flammable fluid (oil, kerosene, hydraulic oil etc.) simultaneously with an ignition source (electrical circuit, hot parts, source of sparks . . . ).

The internal fixed structure of the nacelle and the combustion chamber of the turbomachine can delimit a so-called “hot” “fire” zone. This hot “fire” zone is subject to high temperatures during the operation of the turbomachine, typically greater than 110° C., for example in the environs of 250° C. or even 500° C., including when there is no fire in the turbomachine.

Another “fire” zone may be delimited by the fan casing 15 of the nacelle and the fan, and is a so-called “cool” “fire” zone. When the turbomachine is in operation this cool “fire” zone is subjected, when there is no fire, to temperatures lower than those of the hot “fire” zone.

In order to avoid damaging vital structures of the aircraft when a turbomachine catches fire, current regulations require the presence of an extinguishing device which is able to extinguish a fire breaking out in any of the “fire” zones of the turbomachine, in particular in the so-called “hot” “fire” zone of the turbomachine.

Current extinguishing devices are conventionally mounted under the aircraft wing, in proximity to the pylon on which the turbomachine is mounted, or directly under the pylon, so as to be carried by the pylon or by the wing. These extinguishing devices may consist of spherical bottles of pressurized gas, which resist the internal pressure by limiting the mass of the bottle: for example, they can be cylinders distributed under the pylon and containing Halon, which is a gaseous agent based on bromotrifluoromethane. FIG. 2 illustrates such an extinguishing device comprising spherical bottles 3′ of pressurized gas mounted under the wing 500 of the aircraft, near the pylon 600. These extinguishing devices are used to spray “fire” zones in the event of a fire breaking out in one of the “fire” zones, at the command of the pilot who is informed of the fire when the fire sensors detect a fire in the turbomachine.

However, the extinguishing agent is injected by the upper part of the nacelle, in a position which can be relatively far from the fire to be extinguished. Thus, a large quantity of extinguishing agent must be injected to manage to submerge the “fire” zone for the purpose of extinguishing the fire, which gives rise to considerable losses of extinguishing agent. This gives rise to a significant increase in the weight of the extinguishing device, and therefore of the turbomachine. Ducts can be put in place to convey the extinguishing agent from the cylinders to the “fire” zones in order to inject the extinguishing agent as close as possible to the fire. However, these ducts are complex, heavy, and if one wishes to inject as close as possible to the nacelle, the extension of these lines requires additional connections during the disassembly and reassembly of the nacelle for reasons of maintenance of the turbomachine, which gives rise to complications and safety risks if incorrect connections have been made. Furthermore, the cylinders, incorporated under the wing or under the pylon, degrade the aerodynamics of the flow at the level of the pylon, which decreases the propulsive efficiency of the turbomachine.

Finally, Halon is a gas with a very high greenhouse effect, and therefore very polluting. It therefore tends to be replaced by other less polluting extinguishing agents, such as NOVEC 1230, also known as FK-5-1-12, which is a liquid agent that becomes gaseous on leaving a spraying nozzle.

Known extinguishing devices are suitable for injecting a liquid extinguishing agent other than Halon via a pressurized syringe. For example, the document FR 3,077,989 A1 describes an extinguishing device comprising a storage tank of an extinguishing agent, a variable volume chamber, a piston located between the tank and the variable volume chamber, and a gas generator configured to pressurize the extinguishing agent in order to distribute it outside the tank.

Other extinguishing devices, such as that described in the document FR 3,060,652 A1, make provision for smothering the fire in “fire” zones of a nacelle by choking, using a suitable gas to move a flexible extinguishing wall toward the “fire” zone of the nacelle, in order to dispense with chemical extinguishing agents.

Finally, the document FR 3,041,936 A1 describes an extinguishing device comprising a tank of extinguishing agent located upstream of the fan casing of the nacelle. The extinguishing agent can be released by the explosion of an explosive cartridge. However, the extinguishing device is then located far from the so-called “hot” “fire” zone of the nacelle, and the extinguishers are not configured to inject the extinguishing agent into it. Consequently, this extinguishing device does not make it possible to effectively extinguish a fire breaking out in this hot “fire” zone. Extinguishing a fire in the hot “fire” zone would presuppose the addition of complex ducts to connect the extinguisher to the internal fixed structure of the nacelle. Furthermore, the extinguishing device itself could not be moved to the level of the internal fixed structure of the nacelle, since it has a limited resistance to high temperatures, and would not withstand the temperatures to which the hot “fire” zone of the nacelle is exposed.

### SUMMARY OF THE INVENTION

One objective of this invention is to make provision for an assembly suitable for providing extinguishing in a so-called “hot” “fire” zone of a turbomachine with improved efficiency by comparison with the prior art.

According to a first aspect, the invention relates to an assembly for an aircraft turbomachine, comprising:
a nacelle extending substantially around a longitudinal axis, said nacelle comprising a fixed structure suitable for being disposed around the turbomachine, said fixed structure comprising an internal surface suitable for delimiting with an external surface of the turbomachine a “fire” zone of the nacelle,
a thermal protection covering the internal surface of the fixed structure of the nacelle at the level of the “fire” zone of the nacelle, and
an extinguisher designed to extinguish a fire in the “fire” zone of the nacelle, said extinguisher comprising a tank suitable for containing an extinguishing agent, the assembly being characterized in that said tank is located between the thermal protection and the internal surface of the fixed structure of the nacelle.

Certain preferred but non-limiting features of the assembly described above are as follows, taken individually or in combination:
the extinguisher further comprises a variable volume chamber, a piston located between the tank and the variable volume chamber, a gas generator configured to inject a propellant gas into the variable volume chamber, said injection of propellant gas being suitable for giving rise to a movement of the piston to pressurize the extinguishing agent, and a spraying nozzle configured to expel the pressurized extinguishing agent out of the tank;
the extinguisher is mounted fixedly on the fixed structure of the nacelle such that a position and an orientation of the tank and/or of the spraying nozzle are fixed with respect to the internal surface of the fixed structure;
the gas generator is mounted at a distance from the tank, between the internal surface and an external surface of the fixed structure of the nacelle, and the extinguisher further comprises a connecting tube suitable for connecting the gas generator and the variable volume chamber;
the thermal protection comprises a cowl for accessing the extinguisher;
the thermal protection is configured to at least partially delimit an enclosure suitable for housing the extinguisher, and the enclosure is a ventilated enclosure comprising a ventilation inlet and a ventilation outlet;
the assembly comprises at least two extinguishers configured to expel the extinguishing agent at the level of one and the same previously determined injection point, and further comprises a control unit suitable for activating the two extinguishers of said pair independently of one another;
each of the extinguishers is suitable for expelling the extinguishing agent at the level of the previously determined injection point by way of a spraying nozzle shared by the two extinguishers, the tanks of each of the two extinguishers being connected to said shared spraying nozzle;
the fixed structure is an internal fixed structure;
the fixed structure is a fan casing;
the fixed structure is an intermediate casing.

According to a second aspect, the invention relates to a propulsion system for an aircraft, comprising an assembly according to the first aspect and a turbomachine, the fixed structure of the nacelle being suitable for being disposed around said turbomachine.

According to a third aspect, the invention relates to an aircraft comprising a propulsion system according to the second aspect, wherein each extinguisher of the assembly is located between the thermal protection and an internal surface of the fixed structure of the nacelle.

### DESCRIPTION OF THE FIGURES

Other features, aims and advantages of this invention will become apparent on reading the following detailed description, given by way of non-limiting example, which will be illustrated by the following figures:

FIG. 1, already commented on, is an exploded view of a nacelle and of a turbojet engine of an aircraft of the prior art.

FIG. 2, already commented on, is a wire frame view of an extinguishing assembly for an aircraft of the prior art.

FIG. 3 is a perspective section view of an assembly comprising a nacelle and an extinguishing device according to an embodiment of the invention.

FIGS. 4a and 4b are schematic section views of an assembly according to an embodiment of the invention and of a turbojet engine, wherein an extinguisher is located between the thermal protection and the internal surface respectively of the internal fixed structure of the nacelle and of the fan casing of the nacelle.

FIG. 5 is a schematic side view of an extinguisher of an assembly according to an embodiment of the invention.

FIGS. 6a and 6b are respectively a schematic front view and a schematic side view of an extinguisher mounted on a fixed nacelle structure of an assembly according to an embodiment of the invention.

FIGS. 7a and 7b are respectively a schematic side view and a schematic bottom view of an extinguisher mounted on a fixed nacelle structure of an assembly according to an embodiment of the invention, wherein a cowl of the thermal protection is mounted on the fixed structure of the nacelle.

FIGS. 8a and 8b are respectively a schematic side view and a schematic bottom view of an extinguisher mounted on a fixed nacelle structure of an assembly according to an embodiment of the invention, wherein a cowl of the thermal protection is mounted on the extinguisher.

FIG. 9 is a schematic side view of a ventilated enclosure housing an extinguisher of an assembly according to an embodiment of the invention.

FIG. 10 is a schematic side view of an assembly according to an embodiment of the invention comprising a pair of two extinguishers associated with a previously determined injection point, and of a turbojet engine.

FIG. 11 is a schematic side view of a pair of two extinguishers of an assembly according to an embodiment of the invention, both extinguishers being associated with a previously determined injection point and comprising a shared spraying nozzle.

FIG. 12 is a schematic side view of a pair of two extinguishers of an assembly according to an embodiment of the invention, both extinguishers being associated with a previously determined injection point and comprising two separate spraying nozzles.

FIG. 13a is a schematic perspective view of an assembly according to an embodiment of the invention comprising two extinguishers mounted on the fixed structure of the nacelle by way of brackets of the fixed structure.

FIG. 13b is a schematic perspective view of a bracket of the fixed structure suitable for mounting an extinguisher on the fixed structure of a nacelle of an assembly according to an embodiment of the invention.

FIG. 14 is a schematic side view of an assembly according to an embodiment of the invention comprising an extinguisher, the tank and gas generator of which are separate.

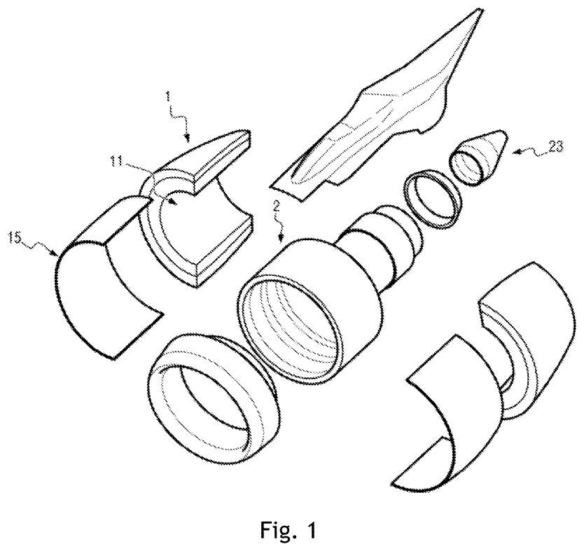

### DETAILED DESCRIPTION OF THE INVENTION

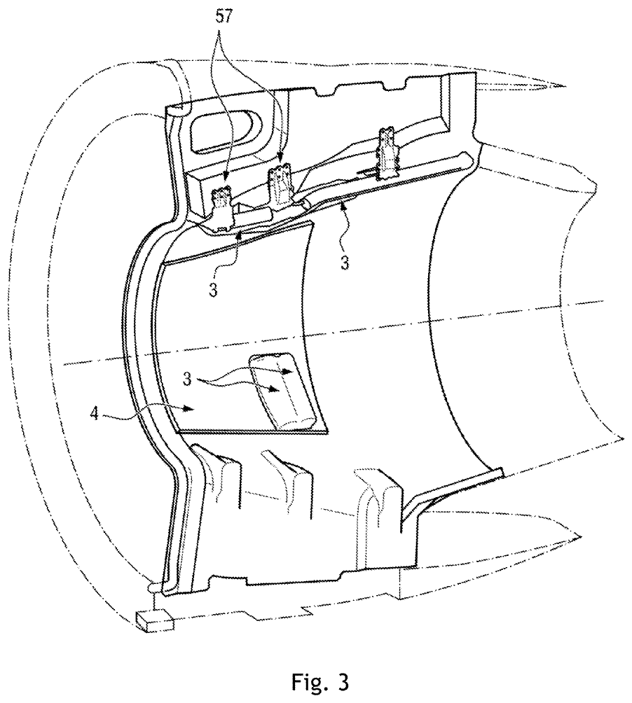

An assembly for an aircraft turbomachine 2 is illustrated by way of non-limiting example in FIGS. 3, 4 and 10. The assembly comprises:
a nacelle 1 extending substantially around a longitudinal axis, said nacelle 1 comprising a fixed structure 11, 15, 16 suitable for being disposed around the turbomachine 2, said fixed structure 11, 15, 16 comprising an internal surface 12 suitable for delimiting, with an external surface of the turbomachine 2, a “fire” zone 100, 200 of the nacelle 1,
a thermal protection 4 covering the internal surface 12 of the fixed structure 11, 15, 16 of the nacelle 1 at the level of the “fire” zone 100, 200 of the nacelle 1, and
an extinguisher 3 designed to extinguish a fire in the “fire” zone 100, 200 of the nacelle 1, said extinguisher 3 comprising a tank 31 suitable for containing an extinguishing agent.

Said tank 31 is located between the thermal protection 4 and the internal surface 12 of the fixed structure 11, 15, 16 of the nacelle 1.

In this application, the upstream and the downstream are defined with respect to the normal direction of flow of the gas through the turbomachine. The longitudinal axis along which the nacelle 1 mainly extends corresponds to an axis of rotation of the turbomachine fan. A radial axis is an axis perpendicular to the longitudinal axis and passing through it. A transverse axis is an axis perpendicular to the longitudinal axis and not passing through it. A longitudinal direction, or a radial direction and transverse direction respectively, corresponds to the direction of the longitudinal axis, or the radial and transverse axis respectively.

The terms internal and external, respectively, are used with reference to a radial direction such that the internal part or face of an element is closer to the longitudinal axis than the external part or face of the same element.

The turbomachine can for example be a turbojet engine or a turboprop engine.

The turbomachine comprises a fan, at least one compressor, a combustion chamber, at least one turbine, and a gas exhaust nozzle. For example, the turbomachine may comprise a low-pressure compressor and a high-pressure compressor, and a high-pressure turbine and a low-pressure turbine.

A turbojet engine can be a bypass turbojet engine, in which the mass of air taken in by the fan is divided into a primary flow which traverses the at least one compressor, the combustion chamber and the at least one turbine, and a secondary flow which is concentric with the primary flow. The primary flow circulates in a primary air path Vp and the secondary flow circulates in a secondary air path Vs.

The turbomachine 2 is housed in a nacelle 1. The fan can therefore be ducted. The nacelle 1 is attached to a pylon 600, or mast, which supports the turbomachine 2, said pylon 600 being attached under a wing 500 of the aircraft.

The nacelle 1 may comprise an air intake upstream of the turbomachine 2, a fan casing 15 surrounding the fan, an intermediate casing 16 surrounding at least one compressor of the turbomachine 2, and an Internal Fixed Structure (IFS) 11 surrounding at least the combustion chamber of the turbomachine 2. The internal fixed structure 11 can moreover surround all or part of the compressor and/or turbine stages of the turbomachine 2. The intermediate casing 16 can be located in the immediate extension of the internal fixed structure 11. The gas exhaust nozzle 23 of the turbomachine 2 is located downstream of the internal fixed structure 11.

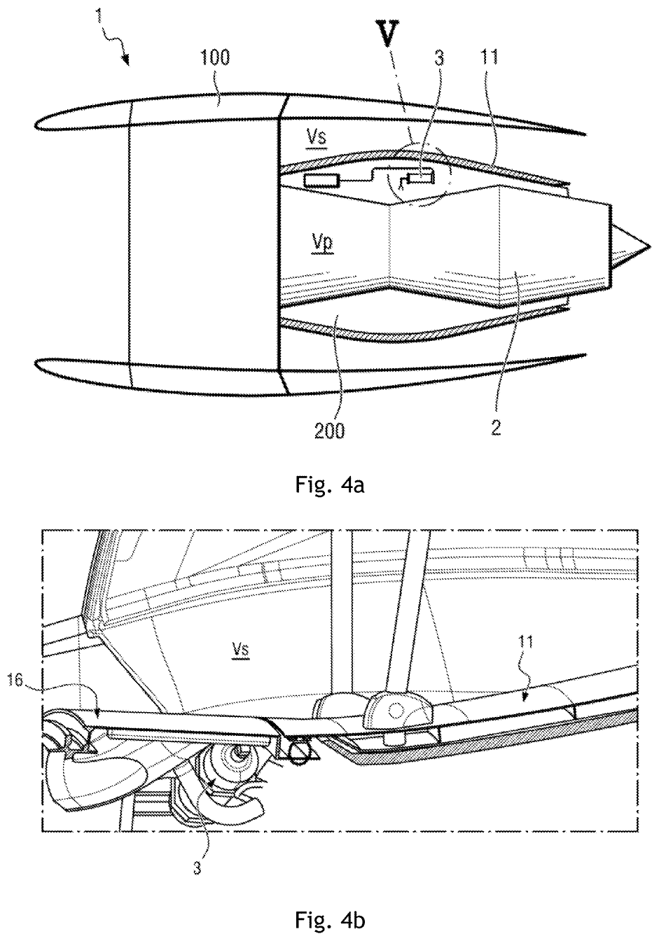

A “fire” zone 200 of the nacelle 1 delimited by the internal surface 12 of the internal fixed structure 11 and an external surface of the combustion chamber of the turbomachine 2 is a so-called “hot” “fire” zone 200. This hot “fire” zone 200 is subjected to high temperatures during the normal operation of the turbomachine 2, i.e. when there is no fire, typically greater than 110° C., for example in the region of 250° C. or even 500° C. FIG. 4a illustrates a simplified example of such a “fire” zone 200.

A so-called “cool” “fire” zone 100, also shown on FIG. 4a, is delimited by the fan casing and/or the intermediate casing 16 of the nacelle 1 and the fan. The cool “fire” zone is subjected, during the normal operation of the turbomachine 2, i.e. when there is no fire, to temperatures lower than that of the “fire” zone 200.

The extinguisher 3 of the assembly described above is incorporated into the structure of the nacelle 1 itself, and is therefore carried by the nacelle 1, and not by the wing 500 or the pylon 600 as in the prior art. Thus, the tank 31 no longer takes up space at the level of the pylon 600, which makes it possible to optimize its positioning and its dimensions with more flexibility.

The fixed structure 11, 15, 16 may be the internal fixed structure 11, the fan casing 15, and/or the intermediate casing 16. For example, at least one extinguisher 3 can be incorporated between the thermal protection 4 and the internal surface 12 of the internal fixed structure 11 of the nacelle 1, i.e. at the level of the combustion chamber of the turbomachine 2. Alternatively or additionally, at least one extinguisher 3 can be incorporated between the thermal protection 4 and the internal surface 12 of the intermediate casing 16 of the nacelle 1, i.e. at the level of a compressor of the turbomachine 2. Alternatively or additionally, at least one extinguisher 3 can be incorporated between the thermal protection 4 and the internal surface 12 of the fan casing 15 of the nacelle 1, i.e. at the level of the fan of the turbomachine 2.

When the extinguisher 3 is incorporated at the level of the intermediate casing 16, the extinguisher 3 can be attached to an internal surface (or internal shroud) of the intermediate casing 16, at a position inward of the internal surface (or internal shroud) of the intermediate casing 16. Said internal surface (or internal shroud) of the intermediate casing 16 delimits an internal wall of the secondary air path Vs. The extinguisher 3 can be located upstream of the internal fixed structure 11, in proximity, for example upstream and in immediate proximity to the internal fixed structure 11, as illustrated by way of non-limiting example in FIG. 4b.

In all cases, the tank 31 of the extinguisher 3 is located at a position outward of the thermal protection 4, and at a position inward of the internal surface 12 of the fixed structure 11, 15, 16. Thus, the thermal protection 4 protects not only the internal surface 12 of the nacelle 1, but also the extinguisher 3, from the high temperatures which can be encountered in the “fire” zones 100, 200 of the turbomachine 2, in particular in the so-called “hot” “fire” zone 200 of the turbomachine 2. The extinguisher 3 therefore benefits from the reduction in temperature provided by the thermal protection 4. The incorporation of the extinguisher 3 thus takes into account the limited resistance of the extinguisher 3 to different temperatures, and thus allows for the correct operation of the extinguisher 3 as close as possible to the “fire” zone 100, 200.

Furthermore, the protection of the extinguisher 3 from high temperatures is provided by the thermal protection 4, which is intended to cover the fixed structure 11, 15, 16 of the nacelle 1 given the high thermal stresses exerted on the nacelle 1 at the level of the “fire” zone 100, 200, in order to keep the internal surface 12 of the fixed structure 11, 15, 16 at temperatures acceptable to its constituent materials, so as to extend its lifetime. Thus, the protection of the extinguisher 3 from high temperatures is provided without requiring any additional protective element.

In addition, the extinguisher 3 is incorporated into the fixed structure 11, 15, 16 of the nacelle 1, within the very zone 100, 200 it is designed to protect from fire. The operation of the extinguisher 3 is thus optimized. In particular, the incorporation of the extinguisher 3 into the fixed structure 11, 15, 16 of the nacelle 1 makes it possible to reduce the length of the supply ducts of the extinguishing agent, or even to dispense with them. Furthermore, since the extinguisher 3 is incorporated as close as possible to the starting points of the fire to be extinguished, it can extinguish the fire at its inception, which contributes to reducing the quantity of extinguishing agent to be used to extinguish a fire breaking out in the “fire” zone 100, 200.

The fixed structure 11, 15, 16 can further comprise an external surface 13 radially opposite the internal surface 12. The external surface 13 of the fixed structure 11, 15, 16 of the nacelle 1 can be adapted to delimit, on the outside, a secondary air path Vs portion of the turbomachine 2. Thus, the air of the secondary flow circulates, at the level of the fixed structure 11, 15, 16, in contact with and outside the fixed structure 11, 15, 16, more precisely in contact with and outside the external surface 13 of the fixed structure 11, 15, 16.

The thermal protection 4 may be a wall attached to the fixed structure 11, 15, 16 of the nacelle 1, for example a wall composed of a thermally insulating coating.

The thermal protection 4 is located in a radially inward position from the internal surface 12 of the nacelle 1. The thermal protection 4 can be radially spaced apart from the internal surface 12, or be contiguous with the internal surface 12.

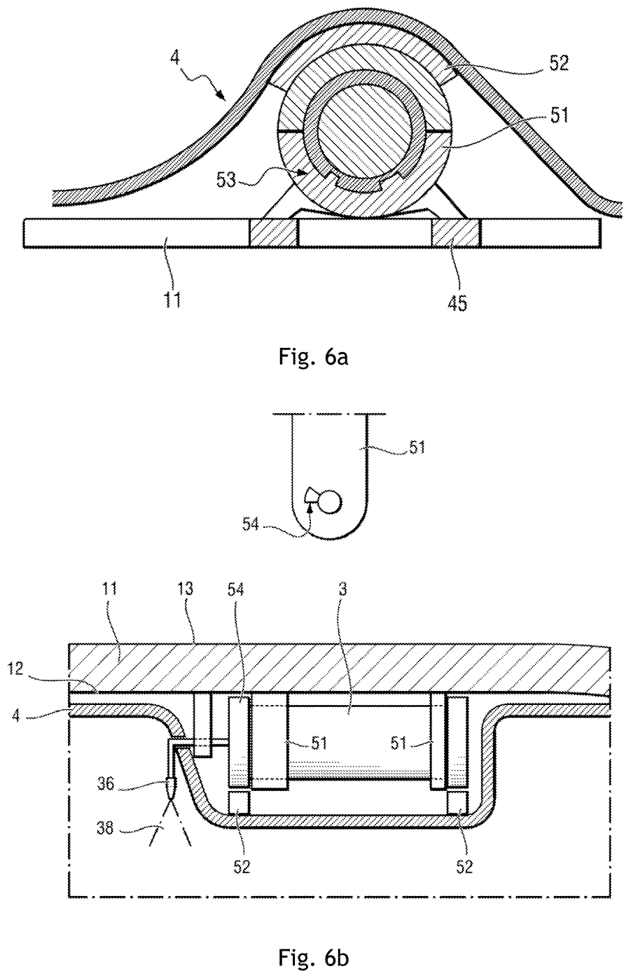

At the level of the extinguisher 3, and as illustrated by way of non-limiting example in FIGS. 6a to 9, the thermal protection 4 is configured to at least partially delimit an enclosure 60 suitable for housing all or part of the extinguisher 3. The enclosure 60 is located at the level of the “fire” zone 100, 200 and is suitable for surrounding the extinguisher 3, so as to protect it from the high temperatures of the “fire” zone 100, 200, particularly when the extinguisher 3 is incorporated into the hot “fire” zone 200.

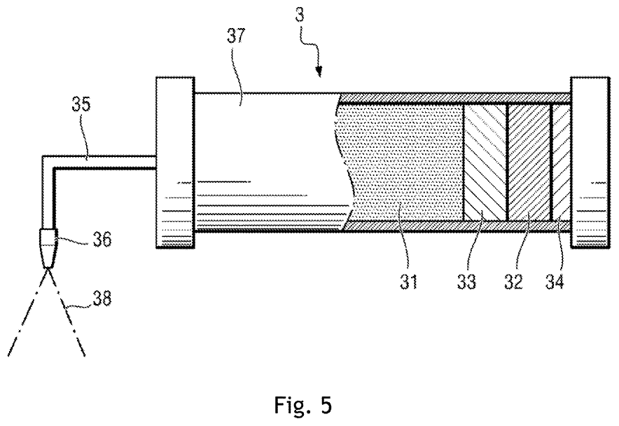

The extinguisher 3, illustrated by way of non-limiting example in FIGS. 5 and 6b, may further comprise a variable volume chamber 32, a piston 33 located between the tank 31 and the variable volume chamber 32, a gas generator 34 configured to inject a propellant gas into the variable volume chamber 32, said injection of propellant gas being suitable for generating a piston movement 33 to pressurize the extinguishing agent, and a spraying nozzle 36 configured to expel the pressurized extinguishing agent out of the tank 31.

The extinguisher 3 may comprise a substantially cylindrical body 37 delimiting the tank 31 and the variable volume chamber 32, and housing the piston 33. The body 37 of the extinguisher 3 comprises a substantially cylindrical body wall, said body wall being closed at one end by a base wall shaped like a disc. The base wall, the body wall and the piston 33 together delimit the extinguishing agent tank 31.

An orifice can be formed in the base wall of the body 37 of the extinguisher 3, for example at a central position of said base wall. The orifice is connected to the spraying nozzle 35, either directly, or via a supply hose 35 of the tank 31. Thus, the extinguishing agent contained in the tank 31 is expelled out of the tank 31 via the orifice when the piston 33 pressurizes the extinguishing agent. The supply hose 35 or nozzle 36 traverses the thermal protection 4, such that the extinguishing agent is expelled directly into the “fire” zone 200.

One may advantageously dispose between the nozzle 36 and the body 37 of the diverter, for example along the hose 35, an insulating part 35bis suitable for creating a break in the thermal bridge between the nozzle 36 and the rest of the extinguisher, so as not to conduct the heat through the body 37 of the extinguisher 3 via the nozzle 36 or the hose 35.

The piston 33 may comprise a disc-shaped body, suitable for being translationally displaced along an axis of the cylinder of the body 37 of the extinguisher 3, by a difference in pressure between the tank 31 and the variable volume chamber 32.

The gas generator 34 forms a device for propelling the extinguishing agent. The gas generator 34 can be activated when an extinguishing is desired, so as to cause the expulsion of the extinguishing agent toward the “fire” zone 100, 200.

The variable volume chamber 32 into which the propellant gas is injected is delimited by the substantially cylindrical body wall of the extinguisher 3, the piston 33, and a separating wall with the gas generator 34. A volume of the variable volume chamber 32 can vary between a zero volume, the piston 33 then being adjacent to the separating wall with the gas generator 34, in contact with said separating wall, and the volume of the tank 31 being at a maximum, and a volume equivalent to a volume of the tank 31, the piston 33 then being adjacent to the base wall of the body 37 of the extinguisher 3, in contact with said base wall, and the volume of the tank 31 being zero.

When the gas generator 34 is activated, it gives rise to a generation of propellant gas in the variable volume chamber 32, which leads to an increase in the volume of the variable volume chamber 32 gradually as the propellant gas is generated, by increasing the pressure of the in the variable volume chamber 32. The movement of the piston 33 under the pressure of the propellant gas propels the extinguishing agent out of the tank 31 and toward the spraying nozzle 36. The extinguishing agent can then travel through the supply hose 335 until it reaches the nozzle 36. The spraying nozzle 36 allows the spraying of the extinguishing agent in the “fire” zone 100, 200, in a spray jet 38. The spray jet 38 coming from the nozzle 36 is a jet of the extinguishing agent, and allows the vaporization and dissemination of the extinguishing agent in gas or two-phase form in the “fire” zone 100, 200.

The extinguishing agent can be NOVEC 1230, also known as FK-5-1-12.

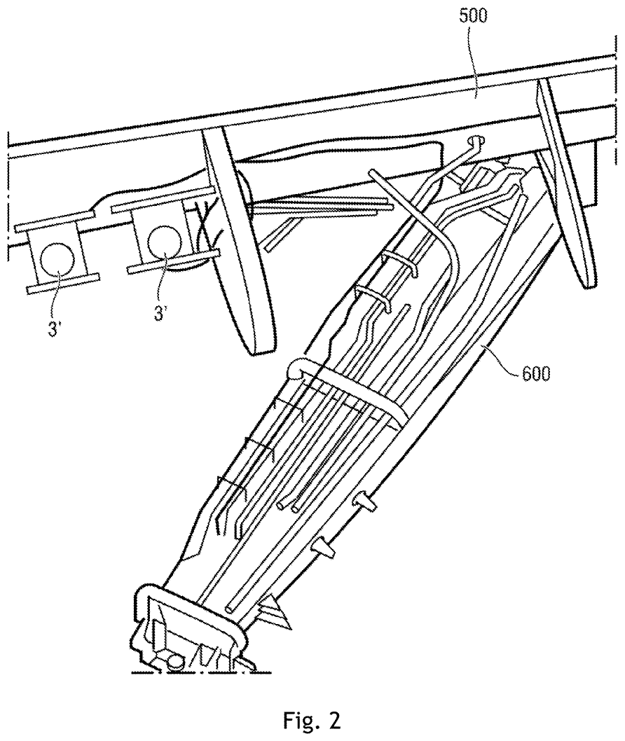

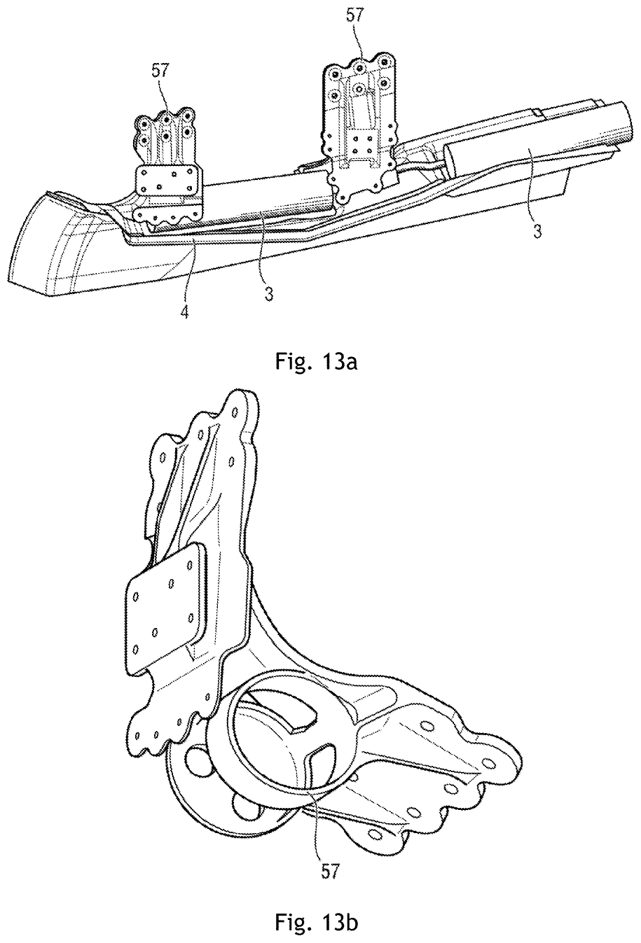

The extinguisher 3, in particular the tank 31 of the extinguisher 3, can be mounted on the fixed structure 11, 15, 16 of the nacelle 1 by way of an extinguisher support 51. The extinguisher support 51 can be incorporated into one or more existing part(s) of the fixed structure 11, 15, 16 of the nacelle 1. For example, and as illustrated by way of non-limiting example in FIGS. 2, 13a and 13b, one or more brackets 57, so-called bumper brackets, of the fixed structure 11, 15, 16 of the nacelle 1 can be adapted to receive the body 37 of the extinguisher 3 so as to attach the extinguisher 3 to the fixed structure 11, 15, 16 of the nacelle 1. Thus, the attachment of the extinguisher 3 to the fixed structure 11, 15, 16 is done by means of existing supports, where applicable with slight modifications, and does not therefore require any additional components. In a variant, the extinguisher support 51 used to attach the extinguisher 3 to the fixed structure 11, 15, 16 can be a dedicated extinguisher support 51 added to the fixed structure 11, 15, 16.

As illustrated by way of non-limiting example in FIG. 6b, the extinguisher support 51 can form a cradle at least partially surrounding the tank 31, where applicable surrounding the body 37 of the extinguisher 3. The extinguisher support 51 can have several separate, spaced-apart supports each surrounding the body 37 of the extinguisher 3, and each attached to the fixed structure 11, 15, 16, in particular to the internal surface 12 of the fixed structure 11, 15, 16, at respective attachment points which are separate and spaced apart. Thus, the extinguisher support 51 allows a particularly reliable attachment of the extinguisher 3. The extinguisher support 51 can moreover comprise a support suitable for partially surrounding the supply hose 35. Thus, the position of the supply hose 35, and therefore of the nozzle 36, is reliability fixed.

The extinguisher support 51, as illustrated by way of non-limiting example in FIG. 6a, can traverse the fixed structure 11, 15, 16 from its internal surface 12 all the way to its external surface 13, so all the way to the air path Vs of the secondary flow. The extinguisher support 51 then forms a heat well, or thermal bridge 45. In particular, when the extinguisher 3 is disposed between the thermal protection 4 and the internal surface 12 of the internal fixed structure 11, the heat well 45 makes it possible to further cool the extinguisher 3.

The extinguisher 3 can be mounted fixedly to the fixed structure 11, 15, 16 of the nacelle 1 such that a position and an orientation of the tank 31 and/or the spraying nozzle 36 are fixed with respect to the internal surface 12 of the fixed structure 11, 15, 16 of the nacelle 1. The fixed structure 11, 15, 16 thus retains the tank 31 and/or the nozzle 36 in a position and an orientation which have been previously determined to ensure the efficient extinguishing of a fire breaking out in the “fire” zone 100, 200. The fixed structure 11, 15, 16 of the nacelle 1 does not then allow the mounting of the tank 31 and/or of the spraying nozzle 36 in a position and orientation that would impair the extinguishing of the fire.

For example, two spraying nozzle 36 supports and/or two tank 31 supports can be present in the enclosure 60 housing the tank 31 of the extinguisher 3, for example mounted fixedly on the internal surface 12 of the fixed structure 11, 15, 16. Two respective rings are mounted on the spraying nozzle 36 and/or on the tank 31. The two nozzle 36 and/or tank 31 supports are suitable for housing the two respective rings mounted on the nozzle 36 and/or the tank 31, in a fixed position and orientation. For example, the two nozzle 36 and/or tank 31 supports can each have particular cavities separate from one another and each have an asymmetrical geometry, the rings of the nozzle 36 and/or of the tank 31 having geometries complementary to those of the nozzle 36 and/or tank 31 supports. Thus, the nozzle 36 and/or tank 31 supports and the rings of the nozzle 36 and/or of the tank 31 impose a single position and orientation of mounting of the nozzle 36 and/or of the tank 31 in the enclosure 60.

The extinguisher support 51 may comprise a poka-yoke for the extinguisher support 53, as illustrated by way of non-limiting example in FIG. 6a. The poka-yoke of the extinguisher support 53 makes it possible to fix the position and orientation of the extinguisher support 51, which attaches the tank 31 to the internal surface 12 of the fixed structure 11, 15, 16. The poka-yoke of the extinguisher support 53 thus makes it possible to impose and fix the position and orientation of the tank 31 with respect to the internal surface 12 of the fixed structure 11, 15, 16. For example, the poka-yoke of the extinguisher support 53 may comprise a conical cradle to foolproof the direction of mounting of the extinguisher 3, or two cradles with different keys.

The extinguisher support 51 may comprise, alternatively or additionally, a nozzle poka-yoke 54 making it possible to fix the position and orientation of the spraying nozzle 36 with respect to the internal surface 12 of the fixed structure 11, 15, 16. For example, the nozzle poka-yoke 54 may comprise a foolproofing key. Thus, it is possible to fix without error and in an optimal direction the position and orientation of the spraying jet 38 of the nozzle 36.

When the position and orientation of the nozzle 36 alone, and not of the tank 31, have been previously determined, the extinguisher support 51 may further comprise an articulated and flexible device suitable for connecting the spraying nozzle 36 to the tank 31, so as to allow a change of orientation and relative position of the nozzle 36 with respect to the tank 31. In particular, the supply hose 35 can be a flexible hose making it possible to reorient and reposition the spraying nozzle 36 independently of the tank 31 of the extinguisher 3. Thus, it is possible to observe the restrictions on the mounting of the tank 31 to the fixed structure 11, 15, 16, which can impose a particular position and/or orientation on the tank 31, while optimizing the position and orientation of the spraying jet 38 of the nozzle 36, which makes it possible to optimize the efficiency of the extinguishing of the fire by the extinguisher 3.

The gas generator 34 is mounted between the thermal protection 4 and the external surface 13 of the fixed structure 11, 15, 16 of the nacelle 1, which delimits the secondary air path Vs.

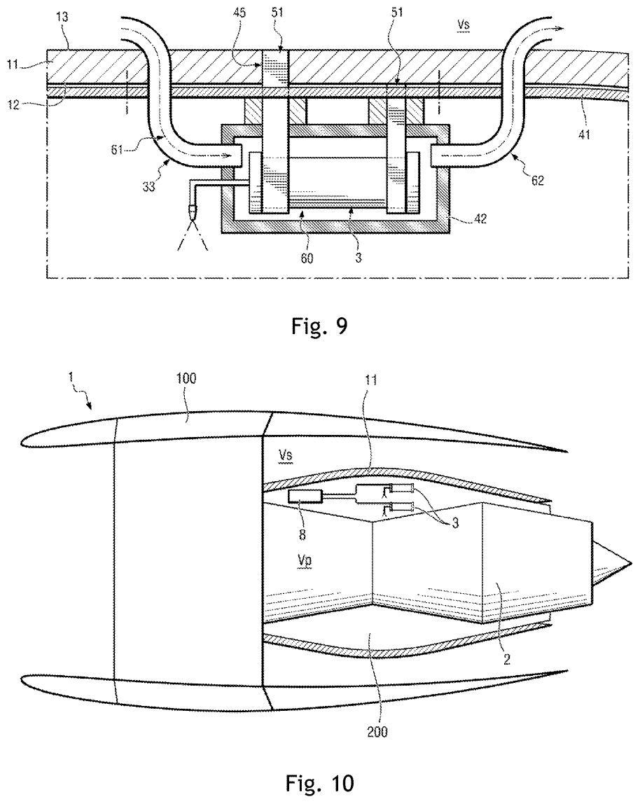

In a first embodiment, illustrated by way of non-limiting example in FIGS. 6b and 9, the tank 31 and the gas generator 34 are both disposed between the thermal protection 4 and the fixed structure 11, 15, 16 of the nacelle 1, more specifically in the enclosure 60 delimited by the thermal protection 4 at the level of the extinguisher 3. The gas generator 34 is then contiguous with the variable volume chamber 32 and opens directly into the variable volume chamber 32, so that the gas is directly generated in the variable volume chamber 32. The substantially cylindrical body 37 of the tank 31 then also houses the gas generator 34.

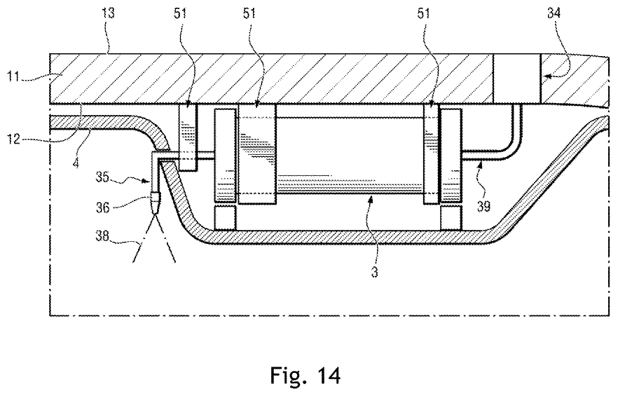

In a second embodiment, illustrated by way of non-limiting example in FIG. 14, the gas generator 34 is mounted at a distance from the tank 31, between the internal surface 12 and the external surface 13 of the fixed structure 11, 15, 16 of the nacelle 1. The extinguisher 3 then also comprises a connecting tube 39 suitable for connecting the gas generator 34 and the variable volume chamber 32.

The tank 31 and the gas generator 34 are then separate and incorporated into two distinct places on the fixed structure 11, 15, 16 of the nacelle 1. Specifically, certain zones of the fixed structure 11, 15, 16 are particularly hot, such as the parts at the level of and downstream of the combustion chamber of the turbomachine 2, i.e. when the extinguisher 3 is located between the thermal protection 4 and the internal surface 12 of the internal fixed structure 11 of the nacelle. However, the gas generator 34 is more sensitive to heat than the tank 31, in that it is particularly vulnerable to overheating. Consequently, separating the gas generator 34 from the tank 31 makes it possible to mount the gas generator 34 in a less hot zone of the fixed structure 11, 15, 16 of the nacelle 1.

In particular, mounting the gas generator 34 between the internal surface 12 and the external surface 13 of the internal fixed structure 11 of the nacelle 1 makes it possible to radially separate it from the primary flow and to bring it closer to the secondary flow, with respect to the tank 31 which is mounted between the thermal protection 4 and the internal surface 12 of the internal fixed structure 11. Thus, the gas generator 34, which is more sensitive to heat, is housed in a cooler zone of the internal fixed structure 11 of the nacelle 1 and benefits from the convective flow provided by the flow of the secondary air path of the engine.

However, due to its small volume, which is smaller than that of the tank 31, the gas generator 34 can be installed between the internal surface 12 and the external surface 13 of the fixed structure 11, 15, 16 of the nacelle 1. This second embodiment therefore makes it possible to optimize the incorporation of the extinguisher 3 into the “fire” zone 100, 200 and of the gas generator 34 into the cooled zone, due to the presence of the separate modules of the tank 31 and of the gas generator 34.

The gas generator 34 can be mounted such that one side of the gas generator 34 is in contact with the external surface 13 of the fixed structure 11, 15, 16, or be mounted flush with the external surface 13 at the level of an opening formed in said external surface 13. Thus, the gas generator 34 is remote from the immediate vicinity of the external surface 13 of the fixed structure 11, 15, 16 of the nacelle 1, and can thus be effectively cooled by the cool secondary flow which circulates in the secondary air path Vs which is delimited outside by the external surface 13 of the fixed structure 11, 15, 16.

Alternatively or additionally, the gas generator 34 can be mounted in contact with a heat well, or thermal bridge 45, of the fixed structure 11, 15, 16, in particular of the internal fixed structure 11, said heat well 45 traversing the fixed structure 11, 15, 16 from its internal surface 12 to its external surface 13 to open into the secondary air path Vs. Thus, the gas generator 34 is effectively cooled by the heat well.

The connecting tube 39 can be a hose connecting the gas generator 34 and the variable volume chamber 32 of the extinguisher 3, and thus makes it possible to inject the propellant gas which is generated by the gas generator 34 into the variable volume chamber 32, for the purpose of displacing the piston 33 to propel the extinguishing agent into the “fire” zone 100, 200, while physically separating the gas generator 34 from the body 37 of the extinguisher 3. The gas generator 34 can also, depending on the desired objective, be directly contiguous with the body 37 of the tank 3 with no connecting tube 39 but in such a way that the gas generator 34 directly penetrates the fixed structure 11, 15, 16 when the extinguisher 3 is installed.

The thermal protection 4 may comprise a cowl 42 for accessing the extinguisher 3, which at least partially delimits the enclosure 60 suitable for housing the extinguisher 3.

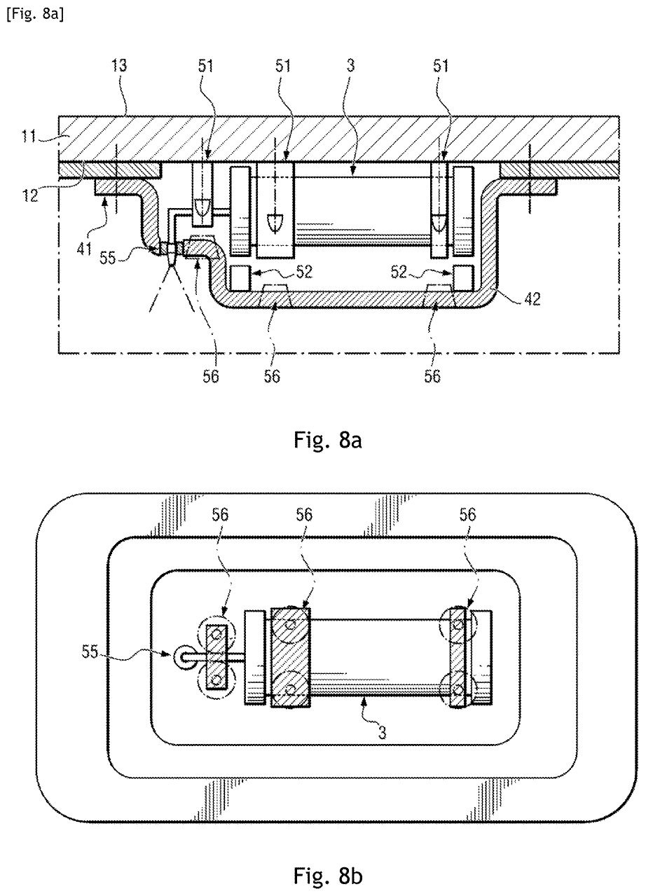

In a first exemplary embodiment, illustrated by way of non-limiting example in FIGS. 8a and 8b, the cowl 42 is mounted directly on the extinguisher 3 by way of first attachments 52. The extinguisher 3 then serves as a support for the cowl 42. The cowl 42 can be removed to make it possible to access the extinguisher 3 without having to dismount the other part(s) 41 of the thermal protection 4, the dismounting of the cowl 42 alone allowing access to the extinguisher 3. The cowl 42 can have a suitable form to assist its gripping during the dismounting and thus make it possible to grip and dismount the extinguisher 3 with the cowl 42 in a single step, the cowl 42 then being dismounted with the extinguisher 3.

The cowl 42 may further comprise one or more dismountable, and thus removable, plugs 56, making it possible, once they are removed, to access the extinguisher support 51 through the thermal protection 4, including the spraying nozzle support 36 when one exists, and/or the supply hose 35 of the extinguisher 3.

An opening 43 can be formed in the cowl 42 so as to allow the passing of the supply hose 35 or of the spraying nozzle 36 through the cowl 42.

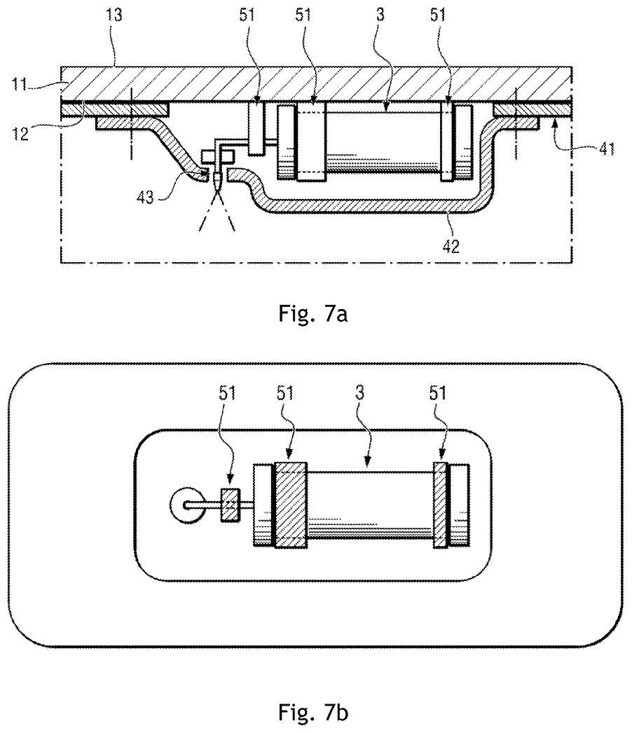

In a second exemplary embodiment, illustrated by way of non-limiting example in FIGS. 7a and 7b, the cowl 42 of the thermal protection 4 is mounted on at least one other part 41 of the thermal protection 4 by way of second attachments. The internal surface 12 of the fixed structure 11, 15, 16 then serves as support to the whole thermal protection 4.

The cowl 42 may comprise a bulkhead connector 55 fixed level with the spraying nozzle 36. The bulkhead connector 55 allows the nozzle 36 to pass through and makes it possible to remove the cowl 42 without dismounting the nozzle 36, while ensuring thermal tightness between the hot zone and the enclosure 60 in which the extinguisher 3 is located.

It is possible for the enclosure 60 suitable for housing the extinguisher 3 to be only partially delimited by the thermal protection 4, the enclosure 60 being moreover partially delimited by the internal surface 12 of the fixed structure 11, 15, 16, as illustrated by way of non-limiting example in FIG. 6a. In other words, the thermal protection 4 is suitable for forming the enclosure 60 with the internal surface 12 of the fixed structure 11, 15, 16. Thus, at the level of the extinguisher 3, the thermal protection 4 is radially spaced apart from the internal surface 12 of the fixed structure 11, 15, 16 of the nacelle 1, such that the space between the thermal protection 4 and the nacelle 1 forms said enclosure 60.

In a variant, and as illustrated by way of non-limiting example in FIG. 9, the enclosure 60 suitable for housing the extinguisher 3 can be entirely delimited by the thermal protection 4. The thermal protection 4 is then disposed so as to entirely surround the extinguisher 3, the thermal protection 4 being moreover attached to the internal surface 12 of the fixed structure 11, 15, 16 of the nacelle 1 by means of a thermal protection support. The thermal protection support can surround the extinguisher support 51, so as to protect the extinguisher support 51 from the high temperatures of the “fire” zone 100, 200.

The enclosure 60 suitable for housing the extinguisher 3 can be a ventilated enclosure comprising a ventilation inlet 61 and a ventilation outlet 62. The ventilated enclosure 60 therefore comprises a specific ventilation circuit, such that the extinguisher 3 benefits from dedicated ventilation and is thus more effectively cooled. In particular, when the gas generator 34 is housed in the body 37 of the extinguisher 3 in the first embodiment, this configuration makes it possible to keep the environment receiving the extinguisher 3 and in particular the gas generator 34 at low temperatures. The air flow around the extinguisher 3 is calibrated to ensure a temperature that is always compatible with the correct operation of the extinguisher 3, in particular of the gas generator 34 in the first embodiment, and with its durability.

The ventilation inlet 61 and/or the ventilation outlet 62 can each be a ventilation hole, or a ventilation intake duct. The hole or duct opens firstly into the ventilated enclosure 60, and secondly into the secondary air path Vs and/or the outside of the nacelle 1. Thus, the enclosure 60 housing the extinguisher 3 is ventilated by drawing fresh air from the secondary air path Vs and/or from outside the nacelle 1.

The ventilation input 61 is located upstream of the enclosure 60 and catches the cool flow from the secondary air path Vs and/or from the outside of the nacelle 1. The ventilation outlet 62 is located downstream of the enclosure 60 and expels the heated flow to the secondary air path Vs and/or to the outside of the nacelle 1. The cool air can be drawn from the secondary air path Vs using the pressure difference between the secondary air path Vs and the “fire” zone 100, 200, the pressure in the secondary air path Vs generally being higher than in the “fire” zone 100, 200.

The cool air drawn from the secondary air path Vs can be used to actuate a vacuum ejector system used to also draw fresh air from outside the nacelle 1, the cool air drawn from outside the nacelle 1 and the cool air drawn from the secondary air path Vs mixing so as to cool the ventilated enclosure 60 still further, and thus protect the extinguisher 3 even more effectively from ambient heat.

The assembly may further comprise a control unit. The control unit is suitable for activating the extinguisher 3, i.e. for driving the expulsion of the extinguishing agent out of the tank 31 of the extinguisher 3. The control unit makes it possible to trigger one or more extinctions in a centralized manner, simultaneously or successively. Thus, the control unit makes it possible to command the extinguishers 3 independently and separately, for example according to the zone and/or extent of the fire.

The control unit can be located in the hot “fire” zone 200, in the cool “fire” zone 100, in the fan compartment, in the mast etc. An electrical cable can be present to connect the control unit to the extinguisher 3, especially to the gas generator 34.

The assembly may comprise at least one pair of two extinguishers 3 configured to expel the extinguishing agent at the level of one and the same previously determined injection point, as illustrated by way of non-limiting example in FIG. 10. For example, the assembly may in total comprise two extinguishers 3 as described above, the two extinguishers 3 forming a pair of extinguishers 3 configured to expel the extinguishing agent at the level of one and the same previously determined injection point. Each pair of two extinguishers 3 is associated with the same previously determined injection point, i.e. the two extinguishers 3 of one and the same pair of extinguishers 3 are configured to expel the extinguishing agent in the immediate vicinity of the previously determined injection point.

The control unit is suitable for activating the two extinguishers 3 of said pair independently of one another, only one of the two extinguishers 3, or as a variant both the extinguishers 3, being activated at each extinguishing request. Thus, both extinguishers 3 of one and the same pair can be activated sequentially so that two injections of extinguishing agent can be carried out consecutively and independently of one another at the request of the pilot and for the same previously determined injection point. The assembly can therefore perform two consecutive and independent extinguishing tests, which is required by the current regulations for in-flight airborne extinguishing devices.

The assembly may comprise several pairs of extinguishers 3, configured to expel the extinguishing agent at several previously determined injection points spaced apart from one another. Thus, the extinguishing of a fire can be optimized according to the location of the fire and/or the extent of the fire. For example, the assembly may comprise four pairs of extinguishers 3 suitable for expelling the extinguishing agent at the level of four previously determined injection points distributed in and/or around the “fire” zone 100, 200.

The two extinguishers 3 of one and the same pair of extinguishers 3 may be located in proximity to one another, or even substantially adjacent to one another.

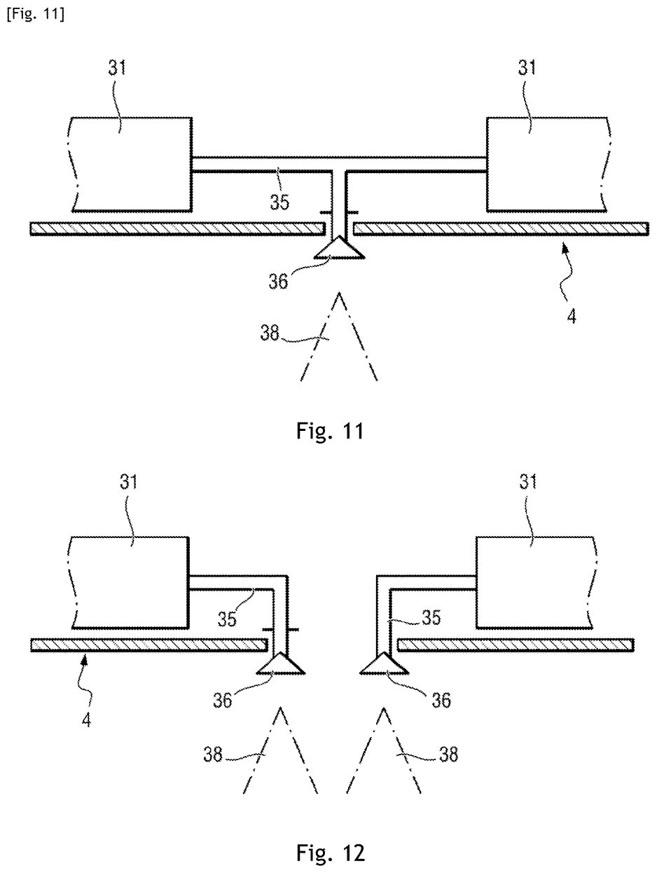

Each of the two activators 3 of the pair can be suitable for expelling the extinguishing agent at the level of the previously determined injection point by way of a spraying nozzle 36 shared by the two extinguishers 3 of the pair, the tanks 31 of each of the two extinguishers 3 of the pair being connected to said shared spraying nozzle 3, as illustrated by way of non-limiting example in FIG. 11. The shared spraying nozzle 36 is located at the level of the previously determined injection point. Each tank 31 of the pair of extinguishers 3 therefore comprises an independent trigger valve, which makes it possible to make two consecutive extinguishings via the same shared spraying nozzle 36.

In a variant, each of the two extinguishers 3 may comprise a respective spraying nozzle 36 specific to the extinguisher 3, the pair of two extinguishers 3 comprising two separate nozzles 36, as illustrated by way of non-limiting example in FIG. 12. The spraying nozzles 36 are then located in immediate proximity to one another, or even substantially adjacent to one another, so as to be both suitable for expelling the extinguishing agent at the level of the previously determined injection point. The tanks 31 of the two extinguishers 3 are each connected to the respective spraying nozzle 36 associated with the tank 31 in question.

A propulsion system for an aircraft may comprise an assembly as described above, and a turbomachine 2. The fixed structure 11, 15, 16 of the nacelle 1 is suitable for being disposed around said turbomachine 2.

An aircraft may comprise a propulsion system as described above. Each extinguisher 3 of the assembly is located between the thermal protection 4 and the internal surface 12 of the fixed structure 11, 15, 16 of the nacelle. Thus, the extinguishers 3 are only included at the level of the propulsion system, the aircraft being devoid of extinguishers in the wings and/or in the fuselage.

1. An assembly for an aircraft gas turbine engine, comprising:
a nacelle extending substantially around a longitudinal axis, the nacelle comprising a fixed structure configured to be disposed around the aircraft gas turbine engine, the fixed structure comprising an internal surface that delimits, with an external surface of the aircraft gas turbine engine, a fire zone of the nacelle,
a thermal protection covering the internal surface of the fixed structure of the nacelle at a level of the fire zone of the nacelle, and
an extinguisher configured to extinguish a fire in the fire zone of the nacelle, the extinguisher comprising a tank for containing an extinguishing agent,
wherein the tank is located between the thermal protection and the internal surface of the fixed structure of the nacelle.

2. The assembly of claim 1, wherein the extinguisher further comprises a variable volume chamber, a piston located between the tank and the variable volume chamber, a gas generator configured to inject a propellant gas into the variable volume chamber to cause a movement of the piston to pressurize the extinguishing agent, and a spraying nozzle configured to expel the pressurized extinguishing agent out of the tank.

3. The assembly of claim 2, wherein the extinguisher is mounted fixedly on the fixed structure of the nacelle such that a position and an orientation of the tank and/or of the spraying nozzle are fixed with respect to the internal surface of the fixed structure.

4. The assembly of claim 2, wherein the gas generator is mounted at a distance from the tank, between the internal surface and an external surface of the fixed structure of the nacelle, and wherein the extinguisher further comprises a connecting tube configured to connect the gas generator and the variable volume chamber.

5. The assembly as claimed in of claim 1, wherein the thermal protection comprises a cowl for accessing the extinguisher.

6. The assembly of claim 1, wherein the thermal protection is configured to at least partially delimit an enclosure for housing the extinguisher, and wherein the enclosure is a ventilated enclosure comprising a ventilation inlet and a ventilation outlet.

7. The assembly of claim 1, comprising:
at least two of the extinguishers configured to expel the extinguishing agent at a level of a same previously determined injection point; and
a control unit that activates the at least two extinguishers independently,
wherein each extinguisher of the at least two extinguishers is configured to expel the extinguishing agent at the level of the same previously determined injection point by a shared spraying nozzle shared by the at least two extinguishers, the tank of each extinguisher of the at least two extinguishers being connected to the shared spraying nozzle.

8. The assembly of claim 1, wherein the fixed structure is an internal fixed structure of the nacelle.

9. A propulsion system for an aircraft, comprising the assembly according to claim 1 and the aircraft gas turbine engine, the fixed structure of the nacelle being disposed around the aircraft gas turbine engine.

10. An aircraft comprising the propulsion system according to claim 9, wherein the extinguisher of the assembly is located between the thermal protection and the internal surface of the fixed structure of the nacelle.
